(19) United States
(12) Patent Application Publication
(10) Pub. No.: US 2007/0198731 A1
(43) Pub. Date: Aug. 23, 2007

(54) System and method for processing multimedia messages

(75) Inventors: Chiu-Wan Li, Chiayi City (TW); Guan-Hua Tu, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/358,542

(22) Filed: Feb. 21, 2006

(51) Int. Cl. G06F 15/16

(52) U.S. Cl. 709/230

(57) ABSTRACT

A method of processing a multimedia message is provided. The multimedia message comprises an original payload. The original payload is divided into at least two sub-messages. A sub-message header for each sub-message is then generated. The sub-message header may include an identification code of the multimedia message, a total number of the sub-messages, and a serial number of the sub-message. The method further appends the sub-message header to each sub-message. Therefore, the sub-messages can be assembled to reconstruct back to the multimedia message according to the sub-message headers.

### BACKGROUND OF THE INVENTION

1. Field of the Invention

The invention relates to multimedia messaging and in particular to methods and systems of providing multimedia messaging services.

2. Description of the Related Art

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Multimedia messaging systems (MMS) have recently become popular recently. MMS-enabled mobile phones enable subscribers to compose and send messages with one or more multimedia parts. Mobile phones with built-in or attached cameras, or with built-in MP3 players are very likely to have a multimedia messaging client, a software program that interacts with the mobile subscriber to compose, address, send, receive, and view multimedia messages.

Multimedia messaging implementation, however, suffers from size limitation due to limited resources. According to a commonly-followed Multimedia Messaging Service Specification provided by the Open Mobile Alliance (OMA), MMS clients conforming to the multimedia message Content Class requirement support a preset minimum message size for each Content Class. For example, the minimum size specified in MMS Conformance Document 1.2 is shown in FIG. 1. Referring to FIG. 1, the minimum sizes for content classes of text, image basic, image rich, video basic, video rich are 30 kB, 30 kB, 100 kB, 100 kB, and 300 kB, respectively.

Additionally, accordingly to the described MMS Conformance Document 1.2, a multimedia messaging client is also required to support multimedia message Content Class Text and at least one other multimedia message Content Class. Accordingly, most multimedia messaging clients support multimedia messaging services for messages not exceeding 300 kB. Theoretically, there is no such size limitation on NMS proxy-relays according to the MMS Specifications.

Practically, however, MMS proxy-relays, as well as multimedia messaging clients, apply a size limitation to multimedia messages. Most size limits, at most 300 kB, are arbitrarily defined and multimedia message exceeding the specified limits are rejected by the MMS proxy-relays.

In addition to the MMS Specification, the size of a multimedia message is also limited by WTP size limitation. According to a WTP specification, a WTP transaction uses 1 byte for a sequence ID, this limits the transaction data volume to about 300K.

According to a conventional multimedia messaging implementation, when a user composes and sends a multimedia message exceeding a size limit predetermined by a sender multimedia messaging client, the multimedia message would be either rejected by the sender multimedia message client, sender Proxy-Relay, or by receiver multimedia messaging client. In the case when the multimedia message is rejected by the sender multimedia messaging client, when a user wants to compose or send a multimedia message exceeding the preset size limit, the composing/sending operation will be rejected by the multimedia messaging client. In a case where the multimedia message is rejected by the sender proxy-relay, the multimedia message, exceeding the size limit of the sender proxy-relay, is wrapped in M-Send.req, which is in turn received by the Sender MMS proxy-relay, and is determined as exceeding the size limit thereof, a M-Send.conf with error return value in X-Mms-Response-Status field is then sent to the sender multimedia messaging client. In a case where the multimedia message is rejected by the receiver multimedia messaging client, at first the multimedia message, exceeding the size limit of the receiver multimedia messaging client, is wrapped in M-Send.req and sent to the receiver multimedia messaging client. The sender proxy-relay receives the M-Send.req, delivers the multimedia message, and returns M-Send.conf to sender with OK value in X-Mms-Response-Status field. The receiver proxy-relay receives the multimedia message and sends the M-notification.ind to the receiver multimedia messaging client. The receiver multimedia messaging client detects that the multimedia message exceeds the size limit thereof, and rejects the multimedia message. If the delivery report M-Delivery.ind is to be sent, the error return value will be in the X-Mms-Status field.

### BRIEF SUMMARY OF INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

A method of processing a multimedia message is provided. The multimedia message comprises an original payload. The original payload is divided into at least two sub-messages. A sub-message header for each sub-message is then generated. The sub-message header may include an identification code of the multimedia message, a total number of the sub-messages, and a serial number of the sub-message. The method further appends the sub-message header to each sub-message. Therefore, the sub-messages can be assembled to reconstruct back to the multimedia message according to the sub-message headers.

Also provided is a system of processing a multimedia message. The system comprises a processor and a storage. The processor divides the multimedia message into sub-messages, each of the sub-messages includes at least one portion of the original payload, generates a sub-message header for each sub-message, wherein the sub-message header includes an identification code of the multimedia message, a total number of the sub-messages, and a serial number of the sub-message, and appends the sub-message header to each sub-message. The storage stores the original multimedia message and the segment messages generated therefrom.

Also provided is a mobile phone. The mobile phone comprises a processor, a communication device, and a storage device. The processor divides the multimedia message into sub-messages, each of the sub-messages includes at least one portion of the original payload, generates a sub-message header for each sub-message, wherein the sub-message header includes an identification code of the multimedia message, a total number of the sub-messages, and a serial number of the sub-message, and appends the sub-message header to each sub-message. The communication device transmits the segment messages. The storage device stores the original multimedia message and the segment messages generated therefrom.

### BRIEF DESCRIPTION OF DRAWINGS

The invention can be more fully understood by reading the subsequent detailed description and examples with references made to the accompanying drawings, wherein:

FIG. 1 illustrates an embodiment of a multimedia message;

FIG. 2A is a schematic view of multipart mixed multimedia messaging system;

FIG. 2B is a schematic view of multipart related multimedia messaging system;

FIG. 3 is a schematic view of an embodiment of a multimedia message concatenation mechanism;

FIGS. 4A-1 and 4A-2 illustrate a first embodiment for a method of segmenting a multimedia message;

FIGS. 4B-1 and 4B-2 illustrate a second embodiment for a method of segmenting a multimedia message;

FIGS. 4C-1˜4 illustrate a third embodiment for a method of segmenting a multimedia message;

FIGS. 5A and 5B illustrate a flowchart of a first embodiment of multimedia message segmentation method; and

FIG. 6 illustrates a flowchart of a second embodiment of multimedia message segmentation method.

### DETAILED DESCRIPTION OF INVENTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constrains, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

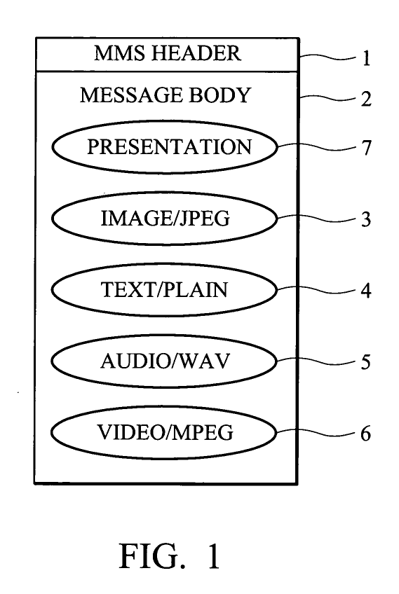

The invention will now be described with reference to FIGS. 1 through 6, which generally relate to a multimedia messaging system. It is understood that multimedia messaging services may transmit messages with image files, video files, sound files, and combination thereof.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

As technology has evolved, bandwidth in mobile radio networks has greatly increased. This increased bandwidth makes it possible for users of mobile devices to send larger messages to one another. These messages can include text, images, video and/or sound. In addition, processing and memory capacity of mobile devices has advanced permitting multimedia messages to be stored in and presented thereby. Therefore, it is now possible and desirable to send multimedia messages to users of mobile devices. The Third Generation Partnership Project (3GPP) initiates the standardization of MMS where the requirements for the first release (release 99) were defined in the following documents: Multimedia Messaging Service: Service aspects; Stage 1, Third Generation Partnership Project TS 22.140 Release 1999, available from www.3gpp.org/ftp/Specs/; and Multimedia Messaging Service: Functional description; Stage 2, Third Generation Partnership Project TS 23.140 Release 1999, available from www.3gpp.org/ftp/Specs/, both of which are hereby incorporated by reference.

Multimedia messaging service has evolved from the popular short messaging service and uses the Wireless Application Protocol (WAP). Multimedia messaging service is a standard for sending and receiving multimedia messages. The multimedia messages can include any combination of formatted text, images, photographs, and audio and video clips. The images can be in any standard format such as GIF and JPEG. Video formats such as MPEG4 and audio formats such as MP3 and MIDI are also supported by multimedia messaging service. The WAP MMS specifications describe the format for the multimedia messages from multimedia messaging proxy relay to the user agent at the terminal with the mandatory steering field (Encapsulation document) and the sequence of these messages (Messaging Service Document) in the following documents: Multimedia Messaging Service: Service aspects; Stage 1, Third Generation Partnership Project TS 22.140 Release 4 (V4. 1.0), available from www.3gpp.org/ftp/Specs/; and Multimedia Messaging Service: Functional description; Stage 2, Third Generation Partnership Project TS 23.140 Release 4 (V4.2.0), available from www.3gpp.org/ftp/Specs/, both of which are hereby incorporated by reference.

The typical format of a multimedia message is illustrated in FIG. 1. The multimedia message includes header 1. The header 1 provides the routing information and addresses of the recipients and senders of the multimedia message. The message body 2 includes images 3, which may be in the form of JPEG; formatted or plain text 4; audio 5, which may be in the form of a .wav file; video 6, which may be in the form of an MPEG file; and may optionally include a presentation file 7 which presents the multimedia content to the recipient of the multimedia message.

There are two types of multimedia messaging systems, one is multipart mixed multimedia messaging system, and the other is multipart related multimedia messaging system.

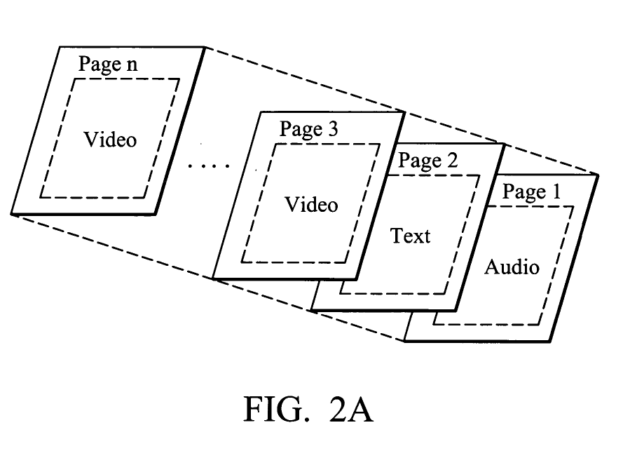

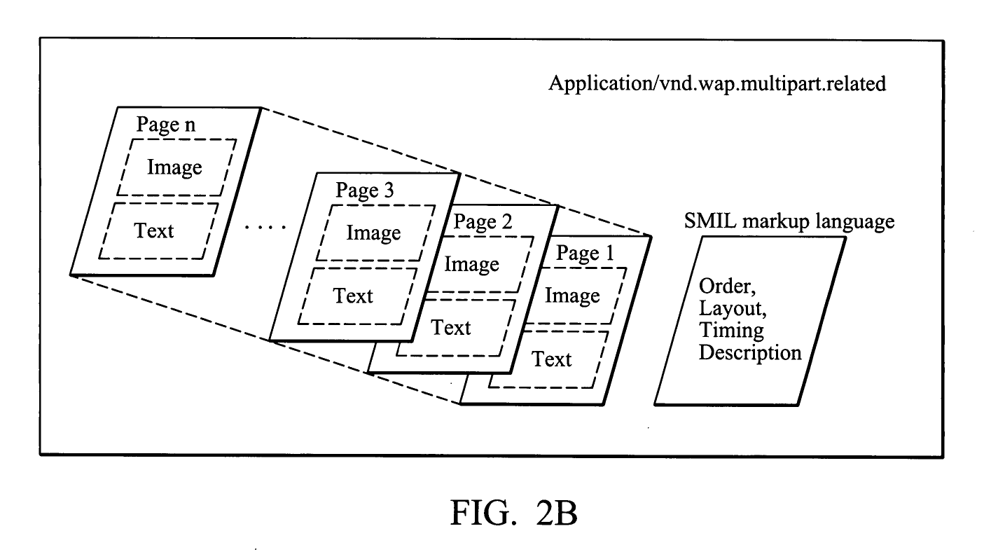

Referring to FIG. 2A, a schematic view of multipart mixed multimedia messaging system is shown. A multipart mixed multimedia messaging system may be considered as a combined chunk of different media objects. When a multipart mixed multimedia message is displayed by a multimedia messaging client, the media objects contained therein are displayed one by one on the screen of the multimedia messaging client. Each of the media objects is encoded as a multipart entry in the multimedia message.

Referring to FIG. 2B, a schematic view of multipart related multimedia messaging system is shown. The display of multipart related multimedia messages resembles a slide show. Each slide may contain an audio clip, some text and an image or video. A multipart related multimedia messaging system, therefore, would contain a presentation part composed in the SMIL (Synchronized Multimedia Integration Language) markup language. The presentation part specifies inserted objects, layout and timing of each slide, and display order of the slide show. Similar to multipart mixed multimedia messaging system, all the media objects and the presentation are encoded as multipart entries in the multipart related multimedia messaging system.

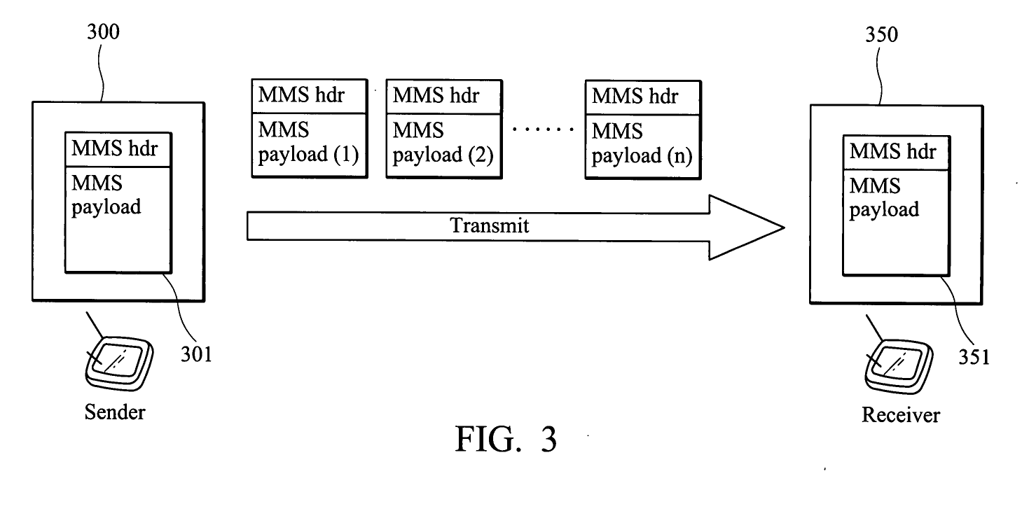

FIG. 3 is a schematic view of an embodiment of a multimedia message concatenation mechanism. Sender 300 composes and sends a multimedia message 301, comprising a multimedia message header and a multimedia message payload. Multimedia message 301 is segmented into a series of multimedia messages 31l˜31n. The multimedia messages 31l˜31n are transmitted to receiver 350, and are reconstructed into a multimedia message 351 by the receiver 350.

A concatenated multimedia message format is provided in the invention based on the characteristics provided by the MMS specification. In the case of a large multimedia message, the payload thereof is segmented into separate messages and additional information is added to the headers of the messages for further reassembling. The additional information may comprise three user-defined header fields, comprising concatenation reference, total parts, and sequence number fields. Each of the user-defined header field conforms to encoding rules specified in OMA/MMS Encapsulation Protocol. Part of the OMA/MMS Encapsulation Protocol 1.2 pertaining to design of the user-defined header field is shown in the following:

Header-field = MMS-header | Application-header
. . .
Application-header = Token-text Application-specific-value
Token-text = Token End-of-string
Application-specific-value = Text-string

The concatenation reference field comprises a concatenation reference, which may be regarded as a transaction identification number (transaction ID) for a concatenation operation. A multimedia messaging client receiving the messages can identify whether a received message belong to any to-be-concatenated message according to the transaction ID. Additionally, several received messages may be reassembled into one multimedia message according to the transaction ID contained therein. The total parts field specifies a total number of messages to be concatenated. The sequence number field specifies a sequence number of the current multimedia message such that the receiver can identify the order to reassemble all segmented messages.

For example, three user-defined header fields are added to the original multimedia message header, comprising ConcatRef, Total, and Seq. The added user-defined header fields are shown in the following:

| | | | | | | | | | | | | | | | | |
|---|---|---|---|---|---|---|---|---|---|---|---|---|---|---|---|---|
| 43 | 6F | 6E | 63 | 61 | 74 | 52 | 65 | 66 | 00 | 45 | 33 | 00 | 54 | 6F | 74 | ; ConcatRef.E3.Tot |
| 61 | 6C | 00 | 35 | 00 | 53 | 65 | 71 | 00 | 33 | 00 | | | | | | ; al.5.Seq.3. |

The sequence “43 6F 6E 63 61 74 52 65 66” represents the concatenate transaction ID ConcatRef. Here, it is “45 33”. The sequence “54 6F 74 61 6C” represents the total size of the concatenate transaction Total. It is “35” in this example. The sequence “53 65 71” represents sequence number Seq and it is “33”.

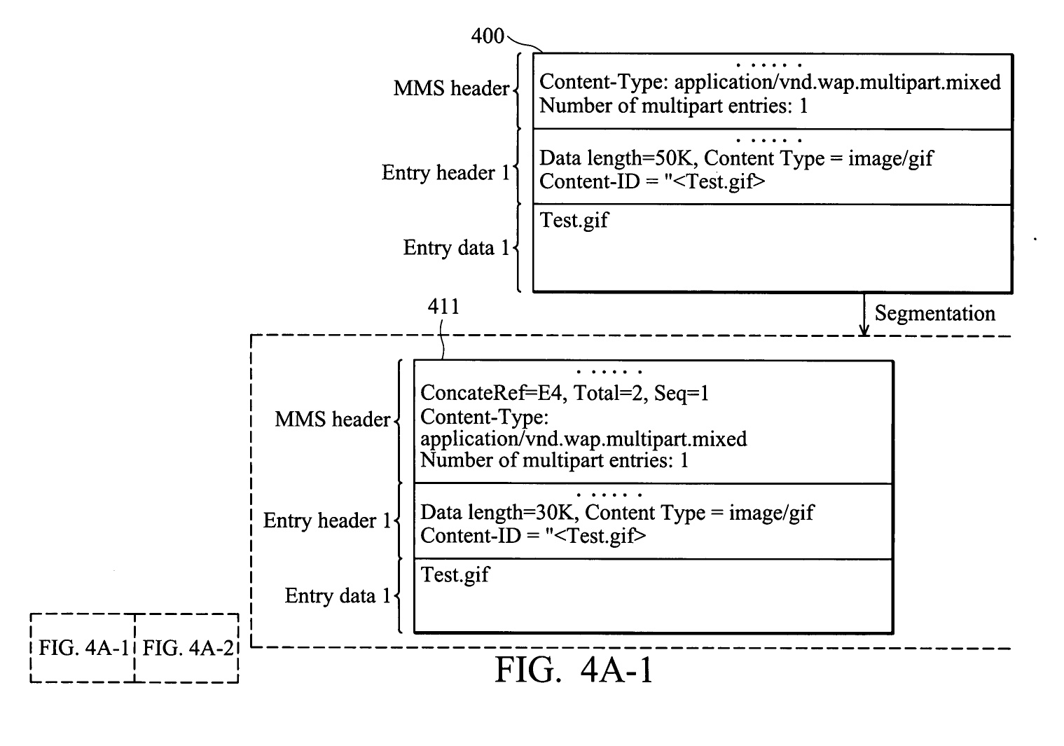

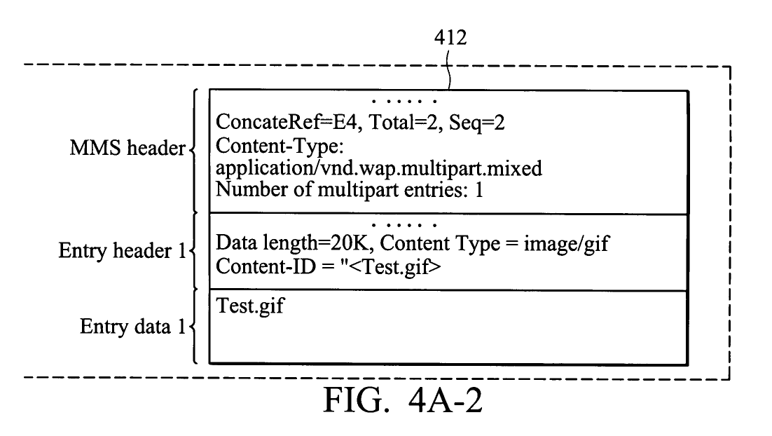

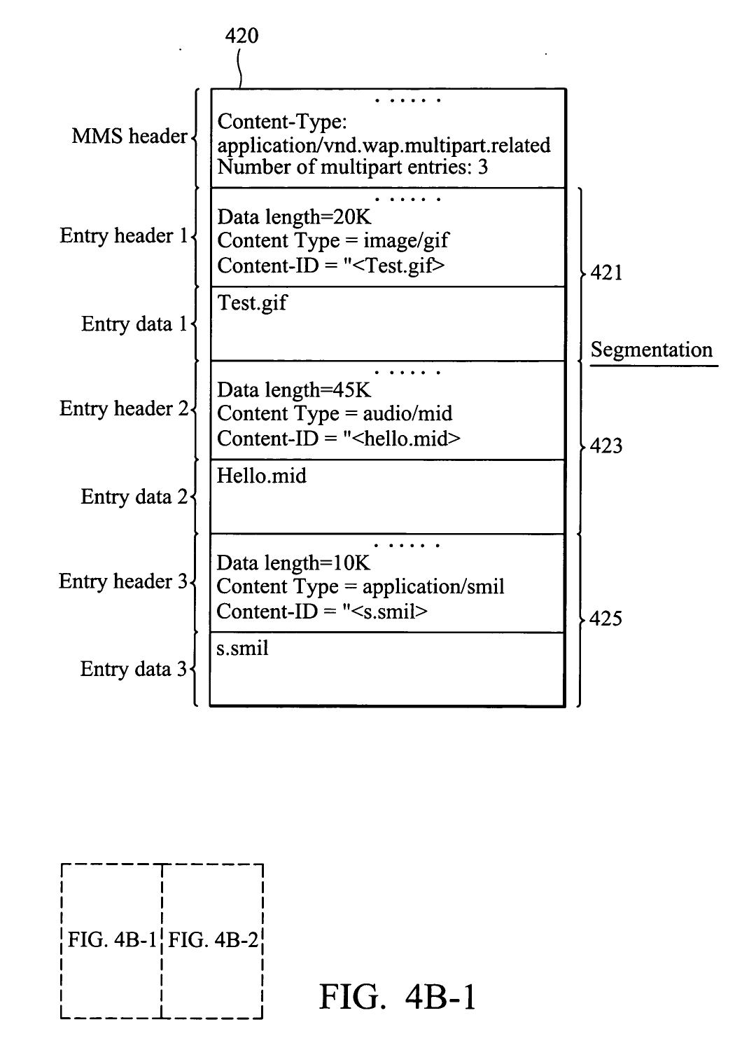

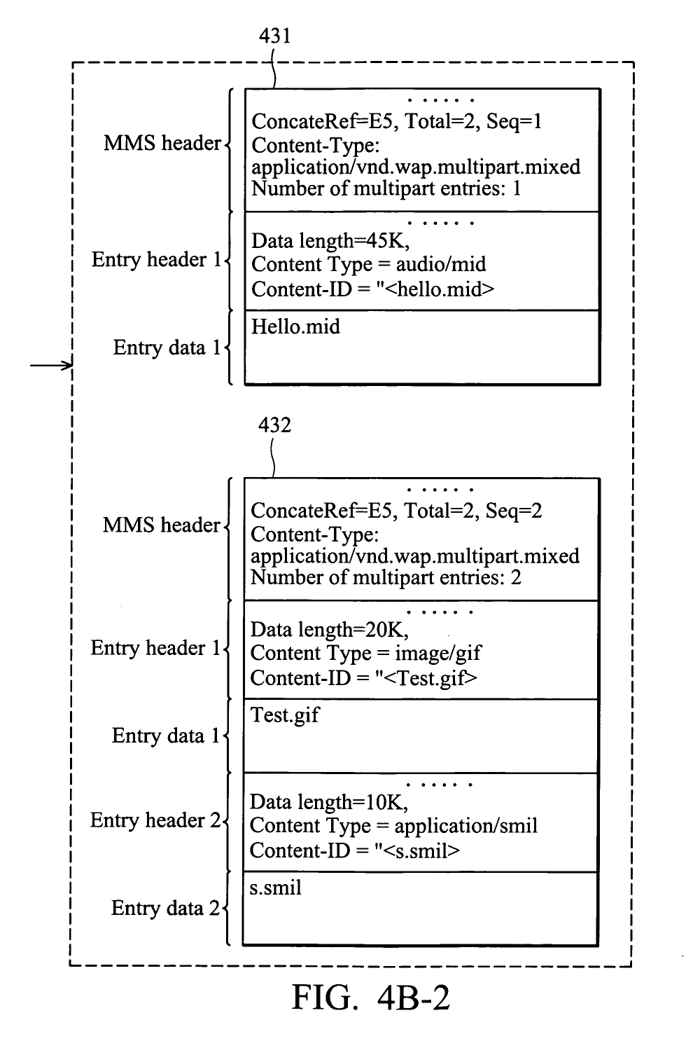

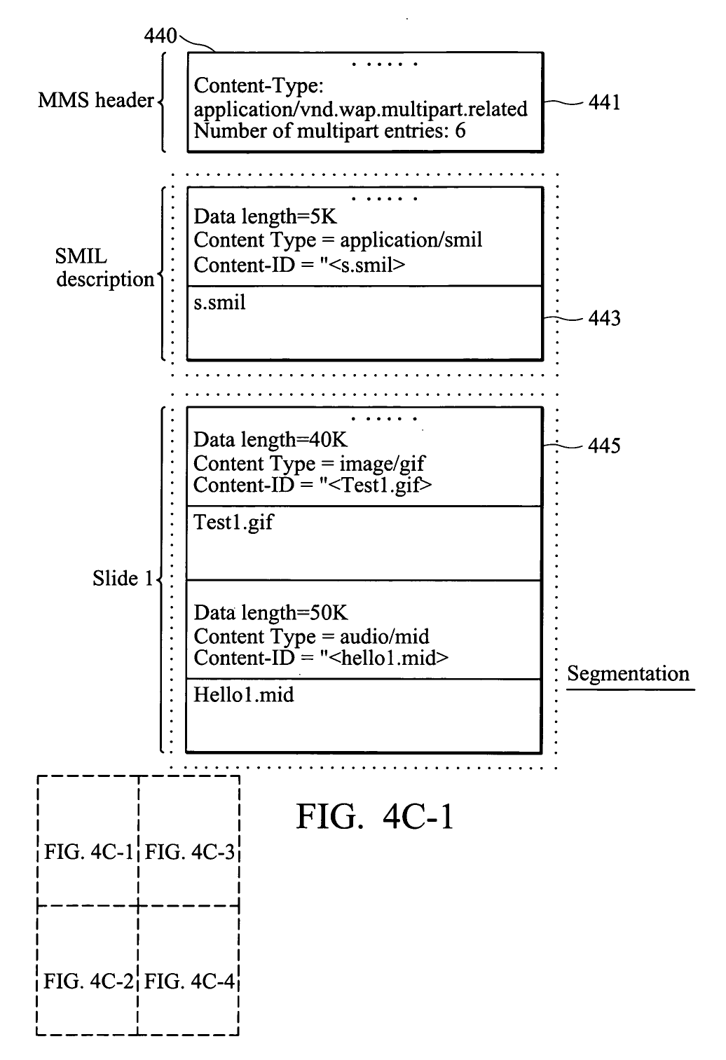

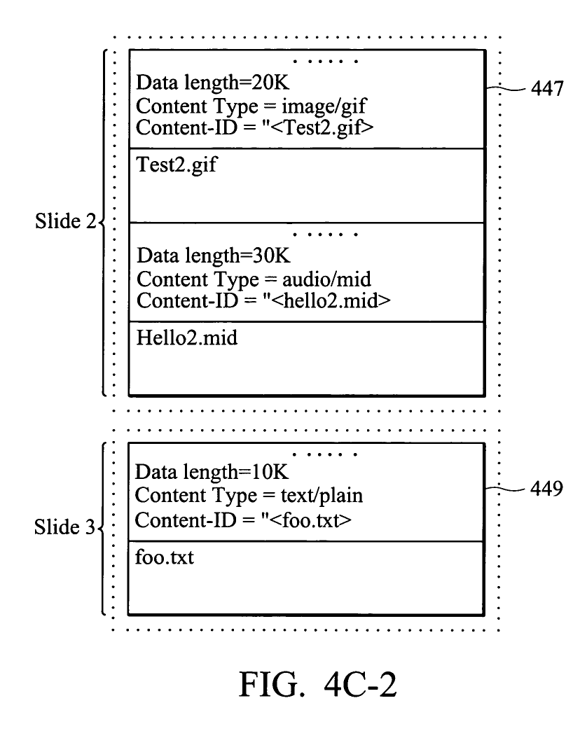

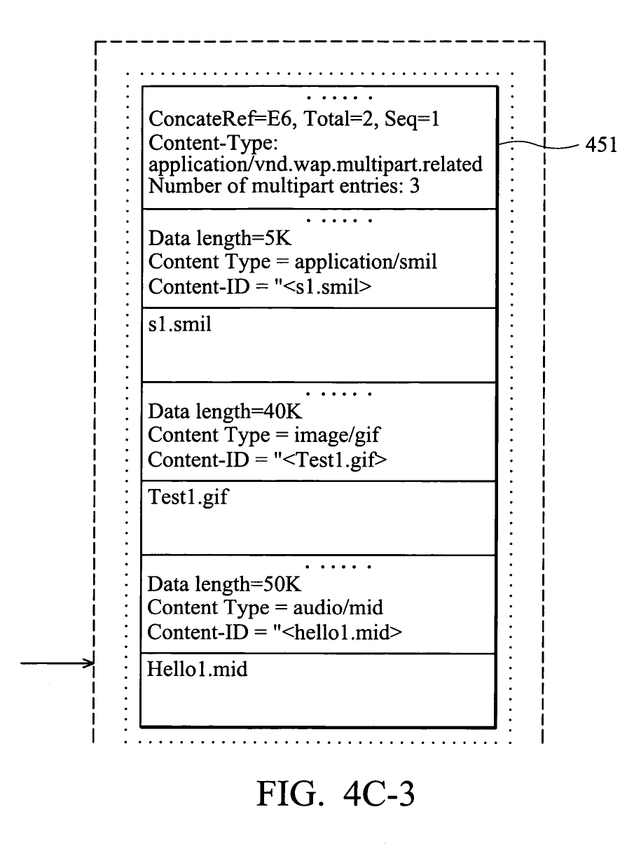

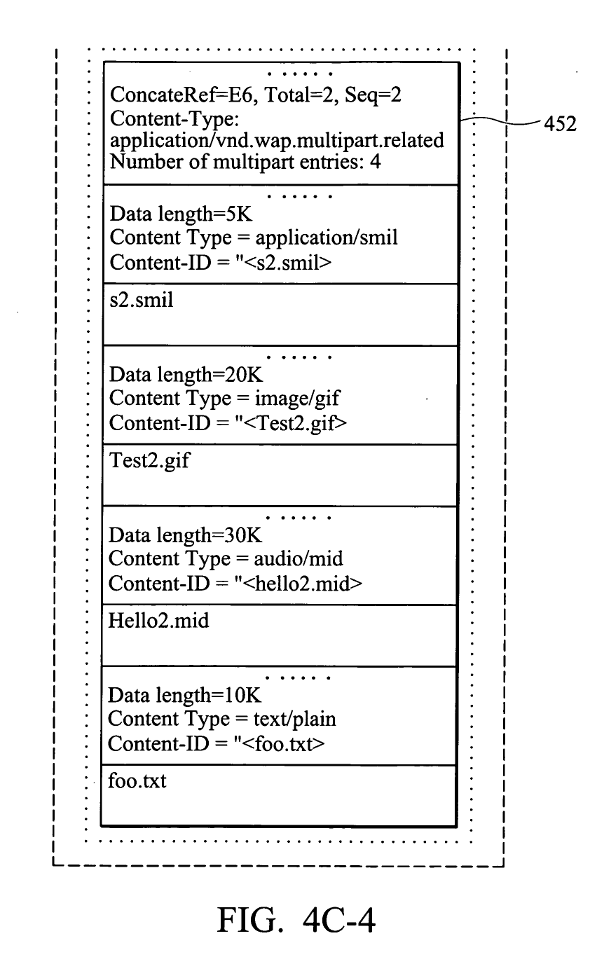

Referring to FIG. 4A, a first embodiment for a method of segmenting a multimedia message is illustrated. The first embodiment for segmenting a multimedia message is referred to as “raw segmentation”. According to the raw segmentation, a multimedia message is segmented into a plurality of messages according to a message size limit. For example, a multimedia message 400 comprising 50 kb of data is segmented into messages 411 and 412. Message 411 comprises 30 kb of data, and message 412, following message 411, comprises 20 kb of data. As illustrated in FIG. 4A, three user-defined header fields are added to messages 411 and 412, respectively. The “ConcateRef fields” of messages 411 and 412 specify that messages 411 and 412 belong to concatenation transaction E4. The “total fields” of messages 411 and 412 specify that the concatenation transaction E4 generates 2 messages in total. The “Seq. fields” of messages 411 and 412 specify that message 411 is the first message generated in the E4 concatenation transaction, while message 412 is the second message generated in the E4 concatenation transaction.

The concatenated messages generated through the raw segmentation can be reassembled by a receiver capable of recognizing the “ConcateRef fields”, “total fields”, and “Seq. fields”. For a receiver unable to recognize the “ConcateRef fields”, “total fields”, and “Seq. fields”, messages 411 and 412 may not be reassembled to reconstruct multimedia message 400 by the receiver.

Referring to FIG. 4B, a second embodiment for a method of segmenting a multimedia message is illustrated. The second embodiment for segmenting a multimedia message is referred to as “multipart-based segmentation”. According to the multipart-based segmentation, a multipart entry is used as a basic unit for segmentation. For example, a multimedia message 420 contains entries 421, 423, and 425, each of which has a header and data payload. Entry 421 contains 20 kb of image data, comprising a ‘gif file’ entitled <test.gif>. Entry 423 contains 45 kb of audio data, comprising a ‘mid file’ entitled <Hello.mid>. Entry 425 comprises 10 kb of application, comprising a ‘smil file’ entitled <s.smil>. Multimedia message 420, comprising 75 kb of data, is segmented into messages 431 and 432. Message 431 comprises 45 kb of data, which is originated from entry 422. Message 432 comprises 30 kb of data, which is originated from entries 421 and 423. As illustrated in FIG. 4B, three user-defined header fields are added to messages 431 and 432, respectively. The “ConcateRef fields” of messages 431 and 432 specify that messages 431 and 432 belong to concatenation transaction E5. The “total fields” of messages 431 and 432 specify that the concatenation transaction E5 generates 2 messages in total. The “Seq. fields” of messages 431 and 432 specify that message 431 is the first message generated in the E5 concatenation transaction, while message 432 is the second message generated in the E5 concatenation transaction.

According to the multipart-based segmentation, a segmented multimedia message may contain at least one multipart entry and represented as a multipart-mixed multimedia message. The concatenated messages generated through the multipart-based segmentation can be reassembled by a receiver capable of recognizing the “ConcateRef fields”, “total fields”, and “Seq. fields”. For a receiver unable to recognize the “ConcateRef fields”, “total fields”, and “Seq. fields”, messages 431 and 432 may also be reassembled to reconstruct multimedia message 420 by the receiver. The received segmented messages 431 and 432 can be displayed independently. The received message can still be displayed even when one of the segmented messages 431 and 432 is missing.

Referring to FIG. 4C, a third embodiment for a method of segmenting a multimedia message is illustrated. The third embodiment for segmenting a multimedia message is referred to as “slide-based segmentation”. According to the slide-based segmentation, a ‘slide’ within a multimedia message is used as a basic unit for segmentation. For example, a multimedia message 440 contains a header 441 and entries 443, 445, 447, and 449. Each of the entries 443, 445, 447, and 449 is presented as a slide. Header 441 specifies the content-type of the multimedia message and the number of multipart entries contained therein. Entry 443 contains the SMIL description of the multimedia message, specifying inserted objects, layout, and presentation timing of each entry contained in the multimedia message, and the order of the slide show. The media objects and the presentation are encoded as multipart entries of the multimedia message. Each of the entries 443, 445, 447, and 449 has a header and data payload. Entry 443 contains 5 kb of SMIL data, comprising a SMIL markup language file entitled <s.smil>. Entry 445 contains 90 kb of data in total, comprising 40 kb of image data entitled <test1.gif> and 50 kb of audio data entitled <Hello1.mid>. Entry 447 contains 50 kb of data in total, comprising 20 kb of image data entitled <test2.gif> and 30 kb of audio data entitled <Hello2.mid>. Entry 449 comprises 10 kb of data, comprising a text file entitled <foo.txt>. Multimedia message 440, comprising 155 kb of data, is segmented into messages 451 and 452. Message 451 comprises 95 kb of data originating from entries 443 and 445. Message 452 comprises 65 kb of data originating from entries 443, 447, and 449. As illustrated in FIG. 4C, three user-defined header fields are added to messages 451 and 452, respectively. The “ConcateRef fields” of messages 451 and 452 specify that messages 451 and 452 belong to concatenation transaction E6. The “total fields” of messages 451 and 452 specify that the concatenation transaction E6 generates 2 messages in total. The “Seq. fields” of messages 451 and 452 specify that message 451 is the first message generated in the E6 concatenation transaction, and message 452 is the second message generated in the E6 concatenation transaction.

According to the slide-based segmentation, a segmented multimedia message may contain at least one slide and be represented as a multipart-related MMS. The concatenated messages generated through the slide-based segmentation can be reassembled by a receiver capable of recognizing the “ConcateRef fields”, “total fields”, and “Seq. fields”. For a receiver unable to recognize the “ConcateRef fields”, “total fields”, and “Seq. fields”, messages 451 and 452 may also be reassembled to reconstruct multimedia message 440 by the receiver. The received segmented messages 451 and 452 can be displayed independently as separate slide items. The received message can still be displayed even when one of the segmented messages 451 and 452 is missing.

Additionally, the sender of multimedia message 440 generates a SMIL part for each of the messages 451 and 452 according to the SMIL part 443 of multimedia message 440. For a receiver supporting the slide-based segmentation, multimedia message 440 is reconstructed from messages 451 and 452 by reconstructing SMIL part 443 from the separate SMIL parts of messages 451 and 452. The procedure requires that the receiver have additional parsing capability.

In addition to the described user-defined header fields, other user-defined fields can be added either to a multimedia message header or to an entry header. For example, a user-defined field specifying checksum, total size, or content object sequence may be added to a multimedia message header or to entry header.

Additionally, a sequence number can be added to a segmented message display. Here, this is done when an incomplete concatenated multimedia message is moved to a viewable folder due to error handling or temporary display. For example, a first segment message may be presented as “Hello World (⅓)”, and a following segment message may be presented as “Hello World (⅔)”.

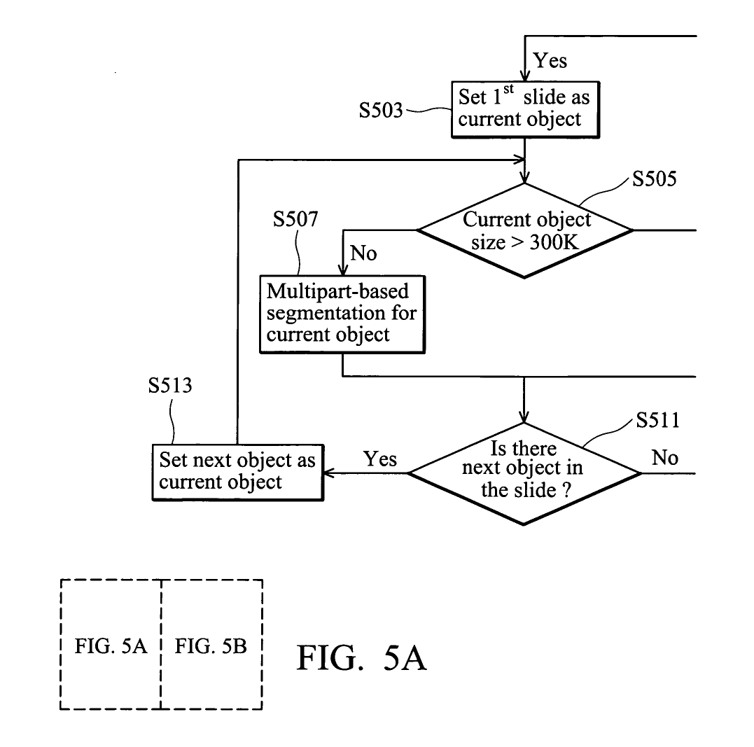

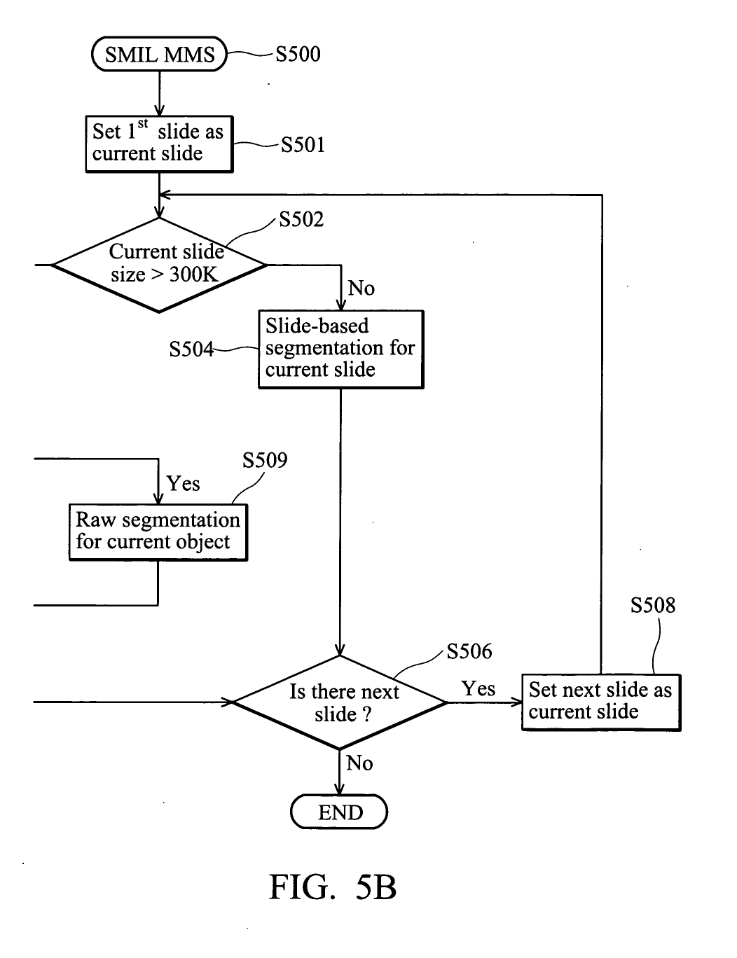

FIG. 5A and FIG. 5B together illustrate a flowchart of a first embodiment of multimedia message segmentation method. The multimedia message segmentation method of FIG. 5A and FIG. 5B is used for segmenting a multipart related multimedia message. In step S500, a multipart related multimedia message is provided. The multipart related multimedia message may be the same as the one shown in FIG. 2B, containing an audio clip, some text and an image or video, as well as a presentation part. The presentation part specifies inserted objects, layout and timing of each slide, and display order of the slide show. All the media objects and the presentation are encoded as multipart entries in the multipart related multimedia message.

In step S501, the first slide of the multipart related MMS is set as a current slide. In step S502, it is determined whether the current slide exceeds 300 kb, and if so, the method proceeds to step S503, otherwise to step S504.

In step S503, the first object of the current slide is set as a current object. In step S505, it is determined whether the current object exceeds 300 kb, and if so, the method proceeds to step S509, otherwise to step S507.

In step S509, the described raw segmentation process is used for segmenting the current object. In step S507, the described multipart-based segmentation is used for segmenting the current object.

In step S511, it is determined whether there is a following object in the current slide that has not been segmented, and if so, the method proceeds to step S513, otherwise to step S506.

In step S504, the described slide-based segmentation process is used for segmenting the current slide.

In step S506, it is determined whether there is a following slide that has not been segmented, and if so, the method proceeds to step S508, otherwise the method ends.

In step S508, a following slide is set as the current slide, and the method then returns to step S502.

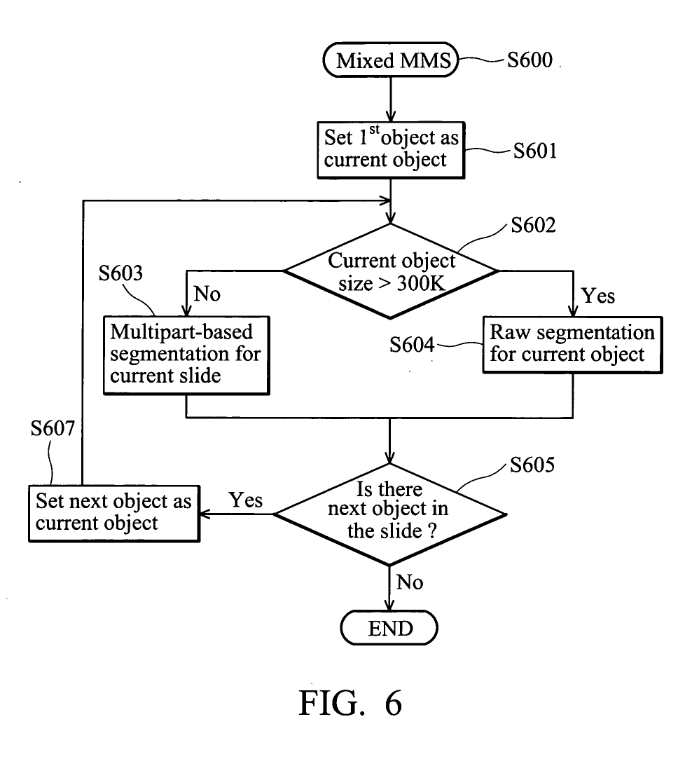

FIG. 6 illustrates a flowchart of a second embodiment of multimedia message segmentation method. The multimedia message segmentation method of FIG. 6 is used for segmenting a multipart mixed MMS.

In step S600, a multipart mixed multimedia message is provided. Multipart mixed multimedia message may be considered as a combined chunk of different media objects. When the multipart mixed multimedia message is displayed by a multimedia messaging client, the media objects contained therein are displayed one by one on the screen of the multimedia messaging client. Each of the media objects is encoded as a multipart entry in the multimedia message.

In step S601, the first object of the multipart mixed multimedia message is set as a current object. In step S502, it is determined whether the current object exceeds 300 kb, and if so, the method proceeds to step S604, otherwise the method proceeds to step S603.

In step S604, the described raw segmentation process is used for segmenting the current object. In step S603, the described multipart-based segmentation is used for segmenting the current object.

In step S605, it is determined whether there is a following object in the current slide that has not been segmented, and if so, the method proceeds to step S607, otherwise the method ends.

For the segmentation processes described here, additional efforts are required for performing the message transaction procedure. At the message sending side, multimedia message segmentation processes are required. Generally, no user operation is involved at the message sending side. At the message receiving side, additional efforts are required in the retrieval procedure when using immediate retrieval mode and delayed retrieval mode, respectively. In the case of immediate retrieval mode, a timeframe concept is introduced to prevent unlimited waiting for an incomplete multimedia message. For example, after the preset waiting timeframe, received partial message packets (partial multimedia message) are discarded or moved to the Inbox of the receiving side as unreadable MMS.

The three described segmentation processes have different characteristics.

For the raw segmentation process, when a device not supporting the raw segmentation process receives a series of segmented messages, meaningful contents may not correctly displayed, or only partial contents can be displayed. When a device supporting the raw segmentation process receives a series of segmented messages, the original multimedia message may be displayed correctly when the series of messages are received completely; when part of the series of segment messages are received, meaningful contents may not displayed correctly, or only partial contents can be displayed.

For the multipart-based process, when a device not supporting the multipart-based process receives a series of messages generated from a multipart mixed multimedia message, separate media objects may be displayed. When a device supporting the multipart-based process receives a series of segmented messages, the original multimedia message may be displayed correctly when the series of messages are received completely; when part of the series of segmented messages (generated from a multipart mixed multimedia message) are received, separate media objects are displayed.

For the slide-based process, when a device not supporting the slide-based process receives a series of messages generated from a multipart related multimedia message, separate slides may be displayed. When a device supporting the slide-based process receives a series of segmented messages, the original multimedia message may be displayed correctly when the series of messages are received completely; when part of the series of segmented messages (generated from a multipart related multimedia message) are received, separate slides are displayed.

The three described segmentation processes can be utilized to meet requirements. Using segmentation of a multipart related multimedia message as an example. In the case where an operator providing a message transmitting service charges by the number of messages, if a message sender is concerned about transmission fees, and a message receiver cannot support any of the described segmentation processes, the multipart based segmentation process may be utilized. According to the multipart based segmentation process, a multipart entry order will not impact the display of the received message. Conversely, if a message sender is not concerned with transmission fees, and is concerned about the display quality instead, the slide-based segmentation process may be utilized.

Additionally, since there is no way to determine server limitations regarding multimedia message size in advance, it is suggested that the size of the segmented message to conform to the specification.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of processing a multimedia message, wherein the multimedia message having an original payload, comprising:
dividing the multimedia message into sub-messages, each of the sub-messages includes at least one portion of the original payload;
generating a sub-message header for each sub-message, wherein the sub-message header includes an identification code of the multimedia message, a total number of the sub-messages, and a serial number of the sub-message; and
appending the sub-message header to each sub-message.

2. The method of claim 1, further comprising:
assembling the sub-messages to reconstruct the multimedia message according to the sub-message headers.

3. The method of claim 1, further comprising:
retrieving a total size of the original payload; and
dividing the original payload into sub-messages according to a predetermined size limit.

4. The method of claim 1, wherein each of the sub-messages comprises one or more entries, each entry contains an entry data which includes parts of the original payload divided into the sub-message, further comprising:
generating an entry header for each entry of the sub-message, each entry header indicating the size of the entry data and the type of the entry data; and
appending the entry header to each entry in the sub-message.

5. The method of claim 1, wherein the original payload comprises a plurality of slides, each of them includes at least a media object, the method further allocates the original payload by slides to each of the sub-message.

6. The method of claim 1, wherein the original payload further comprises an original SMIL (Synchronized Multimedia Integration Language) file, and the method further comprising:
generating a sub-SMIL file for each of the sub-messages according to the original SMIL file.

7. The method of claim 1, further comprising:
checking if all sub-messages generated from the multimedia message are received within a preset time period.

8. A system of processing a multimedia message, wherein the multimedia message having an original payload, comprising:
a processor dividing the multimedia message into sub-messages, each of the sub-messages includes at least one portion of the original payload, generating a sub-message header for each sub-message, wherein the sub-message header includes an identification code of the multimedia message, a total number of the sub-messages, and a serial number of the sub-message, and appending the sub-message header to each sub-message;
a storage storing the original multimedia message and the segment messages generated therefrom.

9. The system of claim 8, wherein the processor further assembles the sub-messages to reconstruct the multimedia message according to the sub-message headers.

10. The system of claim 8, wherein the processor further retrieves a total size of the original payload; and divides the original payload into sub-messages according to a predetermined size limit.

11. The system of claim 8, wherein each of the sub-messages comprises one or more entries, each entry contains an entry data which includes parts of the original payload divided into the sub-message, wherein the processor further generates an entry header for each entry of the sub-message, each entry header indicating the size of the entry data and the type of the entry data, and appends the entry header to each entry in the sub-message.

12. The system of claim 8, wherein the original payload comprises a plurality of slides, each of them includes at least a media object, the processor further allocates the original payload by slides to each of the sub-message.

13. The system of claim 8, wherein the original payload further comprises an original SMIL (Synchronized Multimedia Integration Language) file, and the processor further generates a sub-SMIL file for each of the sub-messages according to the original SMIL file.

14. The system of claim 8, the processor further checks if all sub-messages generated from the multimedia message are received within a preset time period.

15. A mobile phone, comprising:
a processor generating a multimedia message having an original payload, dividing the multimedia message into sub-messages, each of the sub-messages includes at least one portion of the original payload, generating a sub-message header for each sub-message, wherein the sub-message header includes an identification code of the multimedia message, a total number of the sub-messages, and a serial number of the sub-message, and appending the sub-message header to each sub-message;
a communication device transmitting the segment messages; and
a storage device storing the original multimedia message and the segment messages generated therefrom.

16. The mobile phone of claim 15, wherein the processor further assembles the sub-messages to reconstruct the multimedia message according to the sub-message headers.

17. The mobile phone of claim 15, wherein the processor further retrieves a total size of the original payload; and divides the original payload into sub-messages according to a predetermined size limit.

18. The mobile phone of claim 15, wherein each of the sub-messages comprises one or more entries, each entry contains an entry data which includes parts of the original payload divided into the sub-message, wherein the processor further generates an entry header for each entry of the sub-message, each entry header indicating the size of the entry data and the type of the entry data, and appends the entry header to each entry in the sub-message.

19. The mobile phone of claim 15, wherein the original payload comprises a plurality of slides, each of them includes at least a media object, the processor further allocates the original payload by slides to each of the sub-message.

20. The mobile phone of claim 15, wherein the original payload further comprises an original SMIL (Synchronized Multimedia Integration Language) file, and the processor further generates a sub-SMIL file for each of the sub-messages according to the original SMIL file.

21. The mobile phone of claim 15, wherein the processor further checks if all sub-messages generated from the multimedia message are received within a preset time period.
